(19) United States
(12) Patent Application Publication
(10) Pub. No.: US 2024/0010497 A1
(43) Pub. Date: Jan. 11, 2024

(54) METHODS AND APPARATUSES FOR PRODUCING CARBON NANOTUBES, METHODS OF PRODUCING SUCH APPARATUSES, AND STRUCTURES FORMED FROM SUCH NANOTUBES

(71) Applicant: Peter J. Schubert, Carmel, IN (US)

(72) Inventor: Peter J. Schubert, Carmel, IN (US)

(21) Appl. No.: 18/347,439

(22) Filed: Jul. 5, 2023

Related U.S. Application Data
(60) Provisional application No. 63/367,653, filed on Jul. 5, 2022.

(51) Int. Cl. C01B 32/164; C01B 32/162; B01J 23/89; B01J 21/06; B01J 35/10

(52) U.S. Cl. CPC C01B 32/164; C01B 32/162; B01J 23/892; B01J 21/06; B01J 35/10

(57) ABSTRACT

Methods and apparatuses capable of enabling carbon nanotubes (CNTs) to be grown from a structured catalyst to produce zero-chirality strands (fibers), as well as methods for manufacturing catalytic membranes capable of use in such methods and apparatuses and structures produced with such methods, apparatuses, and membranes. Such a method includes forming interlinked cyclic graphene hexagons at a growth site on a permeable catalyst layer disposed on a porous support. The growth site is located over a pore in the porous support. A strand of zero-chiral carbon nanotube is continuously grown from the dome by providing a hydrocarbon feed at a positive pressure through the porous support and the permeable catalyst layer toward the growth site.

### CROSS-REFERENCE TO RELATED APPLICATIONS

This application claims the benefit of U.S. Provisional Application No. 63/367,653 filed Jul. 5, 2022, the contents of which are incorporated herein by reference.

### BACKGROUND OF THE INVENTION

The invention generally relates to carbon nanotubes and to methods and apparatuses used for their production. The invention particularly relates to methods and apparatuses for producing zero-chirality carbon nanotubes of potentially unlimited lengths, methods of producing such apparatuses, and structures formed from such nanotubes.

Armchair or zig-zag single-wall carbon nanotubes (CNTs) require a catalyst to convert hydrocarbon feedstocks into structured crystalline forms. Strands (fibers) produced from CNTs having zero (0) chirality (i.e., a spiral angle of zero) have highly desirable properties, both mechanical and electrical. The chirality of the CNT depends on the shape of the catalyst particle from which it is grown.

Due to the many possible uses of CNT-based materials, it would be desirable to be able to produce continuous CNT strands of very long lengths that could be used for example as structural members or electrical conductors. However, existing methods of forming CNTs do not generate CNTs of determinate sizes and long lengths, and CNT production using a catalyst has limited CNT lengths on the order of 10 cm. Methods have not existed by which continuous CNTs can be grown from a structured catalyst to produce zero-chirality strands of unlimited length.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods and apparatuses capable of enabling carbon nanotubes (CNTs) to be grown from a structured catalyst to produce zero-chirality strands (fibers), as well as methods for manufacturing catalytic membranes capable of use in such methods and apparatuses and structures produced with such methods, apparatuses, and membranes.

According to a nonlimiting aspect, an apparatus for manufacturing a continuous strand of zero-chiral carbon nanotube includes a bi-facial catalytic membrane. The catalytic membrane includes a porous support having opposite first and second sides. The porous support comprises at least one pore extending through the porous support. A catalyst layer is disposed on the first side of the porous support and covers the pore. A surface of the catalyst layer opposite the porous support defines a first face of the bi-facial catalytic membrane, and the second side of the porous support defines a second face of the bi-facial catalytic membrane. The catalyst layer is permeable to allow diffusion of carbon atoms therethrough. The first face is configured to form an end cap of a carbon nanotube, the first face defines the diameter of the carbon nanotube, and the carbon nanotube has a predefined chirality and diameter.

According to another nonlimiting aspect, a method is provided for manufacturing a continuous strand of zero-chiral carbon nanotube. The method includes forming a dome formed of interlinked cyclic graphene hexagons at a growth site on a permeable catalyst layer disposed on a porous support. The growth site is located over a pore in the porous support. The method also includes continuously growing a strand of zero-chiral carbon nanotube from the dome by providing a hydrocarbon feed at a positive pressure through the porous support and the permeable catalyst layer toward the dome.

According to yet another nonlimiting aspect, a method is provided for manufacturing a bi-facial catalytic membrane to produce a continuous strand of zero-chiral carbon nanotube. The method includes directionally coating a first side of a porous support with a permeable catalyst to form a catalyst layer covering a pore of the porous support. The catalyst layer is permeable to allow diffusion of carbon atoms therethrough. A surface of the catalyst layer opposite the porous support defines a first face of the bi-facial catalytic membrane, and a second side of the porous support opposite the first side defines a second face of the bi-facial catalytic membrane. A growth site for an end cap of a carbon nanotube with a predefined chirality and diameter is formed on the first face.

According to still another nonlimiting aspect, a structure is provided that includes first and second strands of zero-chiral carbon nanotubes manufactured according to the methods described above. The first and second strands are knitted together to form a portion of the structure.

Technical aspects of the invention as described above preferably include the capability of producing continuous strands of armchair or zig-zag single-wall carbon nanotubes (CNTs), and the ability to produce cables of such CNTs that are capable of use in power management and distribution between generation sources, energy storage, and loads for a variety of applications, including but not limited to lunar operations. The CNTs are preferably capable of desirable conductive properties and low defect rates, and preferably can be produced as continuous strands of indefinite and potentially unlimited lengths.

Other aspects and advantages will be appreciated from the following detailed description as well as any drawings.

### BRIEF DESCRIPTION OF THE DRAWINGS

FIG. 1 illustrates a catalytic membrane of an apparatus used in a method of manufacturing a continuous zero-chiral carbon nanotube (CNT) according to certain nonlimiting aspects of the invention.

FIGS. 2A-2C illustrate process steps for forming a catalytic membrane utilizing a porous support according to certain nonlimiting aspects of the invention.

FIGS. 3A-3D illustrate process steps for forming the catalytic membrane of FIG. 1, by which the catalytic membrane is formed utilizing a porous support to have apertures for use in the formation of continuous CNTs of a constrained diameter according to certain nonlimiting aspects of the invention.

FIGS. 4A-4D illustrate process steps for forming a catalytic membrane, by which the catalytic membrane is formed utilizing a porous support to have apertures for use in the formation of continuous CNTs of a constrained diameter according to certain nonlimiting aspects of the invention.

FIG. 5 is a partial cross section schematic view of a continuous CNT strand being formed using the catalytic membrane of FIG. 1 according to certain nonlimiting aspects of the invention.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite certain but not necessarily all of the aspects and alternatives described in the detailed description.

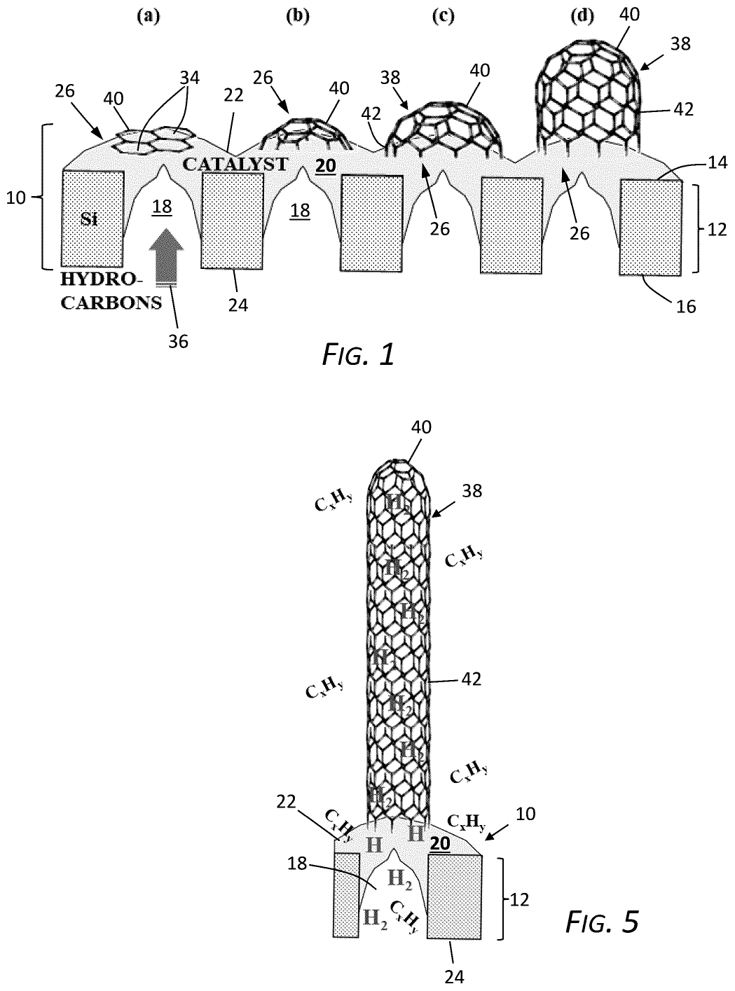

FIGS. 1 through 5 schematically represent nonlimiting embodiments of methods and apparatuses capable of enabling carbon nanotubes (CNTs) to be grown from a structured catalyst to produce zero-chirality strands (fibers), as well as methods for manufacturing catalytic membranes 10 capable of use in such methods and apparatuses and structures produced with such methods, apparatuses, and catalytic membranes 10. To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the catalytic membranes 10 and/or CNT strands 38 produced with the use of such membranes 10, as represented in the drawings. All such relative terms are useful to describe the illustrated embodiment(s) but should not be otherwise interpreted as limiting the scope of the invention.

According to preferred but nonlimiting aspects of the invention, methods and apparatuses are provided that can be used to form a catalyst structure supporting continuous carbon nanotubes (CNTs) having a chiral angle of zero. As represented in FIG. 1, the methods and apparatuses preferably involve the use of one or more of the aforementioned catalytic membranes 10, sometimes referred to herein as bi-facial catalytic membranes 10. Such a membrane 10 can be fabricated as a structured thin film across which a modest pressure differential can be established to drive diffusion of hydrocarbons (CₓH_{y}) through a catalyst layer 20 of the membrane 10, such that carbon atoms dissociate from the hydrocarbon. The membranes 10 are preferably capable of forming CNT strands 38 (or other structure) having customizable diameters and end cap orientations, as well as dense arrays of such strands 38. Additionally, features of such a membrane 10 and the strands 38 produced therewith are preferably customizable. Methods for producing such a membrane 10 preferably have the ability to dial-in key parameters of a CNT, and then grow it as a continuous strand 38. With these CNT strands 38, cables can be formed, for example, segmented, braided, or molded with epoxy, possibly in chains. Multiple parallel nanofactories utilizing such catalytic membranes 10 can expand production very rapidly and become a game-changing technology in many fields. For example, it is envisioned that over time, when cables formed of CNT strands 38 are available at hundreds of megameters, space elevators for the Moon and Mars are conceivable.

FIG. 1 generally represents four growth phases (labeled (a) through (d)) of continuous zero-chirality CNT strands 38 utilizing a catalytic membrane 10 that has a catalyst layer 30 formed of a permeable catalyst. The catalyst layer 30 allows carbon atoms from a hydrocarbon feed 36 to migrate through and form cyclic graphene hexagons that interlink to form the CNT strands 38. The size and shape of the catalyst layer 20 controls the diameters and dome shapes for the CNT strands 38 during initial formation and growth. Phases (a) through (d) represent a time sequence proceeding from left to right that shows the uniform creation of graphene unit cells 34 which coalesce in a thermal dance with the specific shape and composition of the catalyst of the catalyst layer 20. The unit cells 34 can be formed by using a hydrocarbon (as a nonlimiting example, methane) as a feedstock from which carbon can dissociate by the catalytic action of the catalyst layer 20. At phase (a) can be seen a hexane ring formation of unit cells 34 on the surface of the catalyst layer 20 that forms an upper face 22 of the membrane 10. The unit cells 34 are shown as forming at a growth site 26 at the upper face 22 that is opposite a cavity or pore 18 located on a lower face 24 of the membrane 10. At phase (b) can be seen separation of the hexane rings from the surface of the catalyst layer 20 and the formation of an end cap 40 of a CNT strand 38 growing upwardly from the surface of the catalyst layer 20. At phase (c) can be seen the formation of sidewalls 42 of a CNT strand 38 growing upwardly from the surface of the catalyst layer 20. At phase (d) it can be seen that, once established, a CNT strand 38 can be grown indefinitely. Gaseous carbon can be supplied from the upper face 22 and/or the oppositely-disposed lower face 24 of the bifacial catalytic membrane 10 so that a near-zero pressure differential can be established. Hydrogen gas may also be utilized to assist with dynamically balancing pressures. The growth rate of CNT strands 38 using the approach represented in FIG. 1 is not especially high, however, it is massively parallel. That is, a large number of CNT strands 38 can be grown at the same time, and even parallel to each other, across a larger bi-facial catalytic membrane 10 having a large number of pores 18 and growth sites 26. The CNT strands 38 are preferably capable of desirable conductive properties and low defect rates, and can be produced as continuous strands 38 of indefinite and potentially unlimited lengths. Further, it will be possible to knit together continuous strands 38 of CNTs having different or identical lengths to create large-scale structures, as nonlimiting examples, cables of CNT strands that are capable of use in power management and distribution between generation sources, energy storage, and loads for a variety of applications, including but not limited to outer space operations.

FIG. 5 generally shows a CNT strand 38 being inflated by hydrogen (H₂) to prevent buckling and to accelerate the growth rate of the strand 38. This may enable so-called “forest growth” of CNTs, that is, to be able to form a large number of CNT strands 38 simultaneously growing adjacent each other outwardly from the surface of the catalyst layer 20 of the catalytic membrane 10, similar to a forest of tree trunks. The hydrogen gas is provided at a positive pressure on the lower face 24 of the catalytic membrane 10 such that hydrogen gas seeps into the CNT strand 38 through the catalyst layer 20, thereby helping to maintain an aligned columnar growth of CNT strands 38 across a forest array and preventing buckling of individual CNT strands 38. The pressure of the hydrogen gas can be finely controlled across the thickness of the membrane 10 to prevent rupture of either the CNT strand 38 or the catalytic membrane 10 by independent control of hydrogen and hydrocarbon partial pressures. A small amount of tension in the growing CNT strand 38 may also help accelerate growth rate from the surface of the catalyst layer 20. Providing forest growth in this manner may allow faster and/or increased production of CNTs and continuous CNT strands 38 at a larger scale suitable for large scale commercial production.

Additional or alternative means are foreseeable by which to accomplish forest growth of continuous CNT strands. For example, forest growth can be conducted in the presence of acceleration in the direction of growth. This can be accomplished by using Earth's gravity, so the substantially parallel CNT strands grown “downward” toward the center of the Earth's gravity. Alternatively, the bi-facial catalytic membrane 10 and associated apparatus may be mounted within a centrifuge that can be spun at a variety of angular speeds so that, in conjunction with the radius from the center of rotation, the resultant centripetal acceleration away from the catalytic membrane 10 provides a small amount of tension to help accelerate growth rate from the surface of the catalyst layer 20. Other means of providing variable acceleration, such as use on a sled, or in a rocket, may be used such that the acceleration vector is linear, rather than radial, as when a centrifuge is used. Once the growth length of a strand 38 has reached a certain distance, any further length can be guided into a gathering receptacle so that the small amount of tension on the growing CNT strand 38 at the surface of the catalytic membrane 10 is maintained at a desired magnitude.

FIGS. 1 and 5 show the bi-facial catalytic membrane 10 as particularly configured for manufacturing a continuous strand 38 of zero-chiral CNTs according to certain non-limiting aspects of the invention. The catalytic membrane 10 is represented as including a porous support 12 having opposite first and second sides 14 and 16. The porous support 12 is a porous material comprising at least one or more pores 18 extending therethrough. The pores 18 preferably have a lateral dimension of about 2-5 nm in a direction transverse to an axial direction through the porous support 12, but other dimensions are also possible. The porous support 12 is preferably formed of porous silicon, though the use of other materials is foreseeable. The catalyst layer 20 of the membrane 10 is represented as disposed on the first side 14 of the porous support 12 and covering each of the pores 18. In this configuration, the exposed surface of the catalyst layer 20 opposite the porous support 12 defines a first (the “upper”) face 22 of the bi-facial catalytic membrane 10, and the second side 16 of the porous support 12 defines a second (the “lower”) face 24 of the catalytic membrane 10. The catalyst layer 20 is sufficiently permeable to allow diffusion of carbon atoms therethrough.

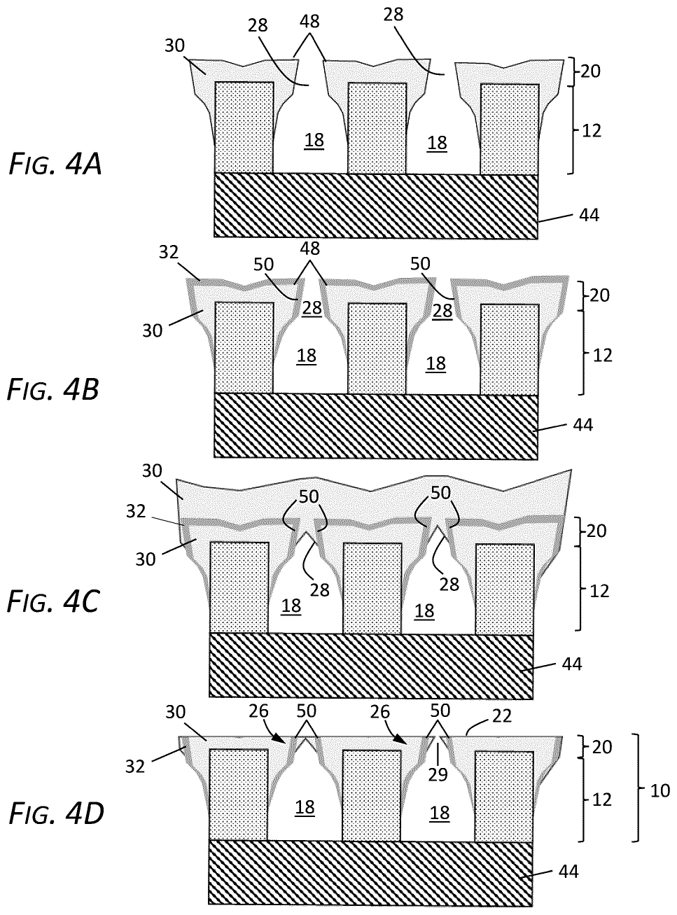

As previously noted, growth sites 26 are located on the upper face 22 of the catalytic membrane 10 and aligned opposite a respective pore 18. The growth sites 26 are topological features on the upper face 22 configured to form the end caps 40 of the CNT strands 38, which are each capable of having a predefined chirality and diameter. In the nonlimiting examples of FIGS. 1 and 5, each growth site 26 has a dome shape projecting outwardly (upwardly) from the upper face 22, but other shapes are also possible. Preferably, the catalyst layer 20 has a plurality of the growth sites 26, each aligned opposite a pore 18, for simultaneously growing a “forest” of CNT strands 38.

Whereas the growth sites 26 of FIGS. 1 and 5 are located on portions of the catalyst layer that completely close their corresponding pores 26, FIG. 4D represents an aperture 29 as extending through the catalyst layer 20 at one of the growth sites 26. The aperture 29 represented in FIG. 4D is aligned with a pore 18 such that a gas can travel in a direction from the lower face 24 to the upper face 22 through the pore 18 and then through the aperture 29. The aperture 29 can be seen to have a cross-sectional area is less than that of an aperture 28 from which it was formed (FIGS. 4B and 4C), and is preferably smaller than a carbon atom and larger than a hydrogen molecule. Further aspects of the embodiment of FIGS. 4A-4D will be discussed below.

Again referring to FIG. 1, phase (a) represents that a continuous strand 38 of zero-chiral CNT can be manufactured by initially forming dome-shaped end caps 40 of interlinked cyclic graphene hexagon-shaped unit cells 34 at growth sites 26 of the catalytic membrane 10. Phases (b), (c), and (d) of FIG. 1 represent progressive growth stages of continuously growing strands 38 of zero-chiral CNT from end caps 40 as a result of providing the hydrocarbon feed 36 at a positive pressure from the lower face 24, through the porous support 12 and the permeable catalyst layer 20 of the membrane 10, and toward the end caps 40 at the upper face 22 of the membrane 10. A tubular sidewall 42, for example, having a generally circular, oval, or polygonal cross-section, grows continuously from the growth sites 26 from the hydrocarbons being continuously fed through the porous support 12 of the membrane 10. As the tubular sidewalls 42 grow, they continuously push their respective end caps 40 farther away from the upper face 22, thereby growing longer and longer until the strands 38 can be eventually cut or removed from the growth sites 26. In this way, a CNT strand 38 can theoretically be grown to an indefinite, approaching infinite length. This may be made easier if, for example, the process is conducted in a very low or no gravity environment, such as in space or on a moon of Mars for example.

The diameter and shape of an end cap 40 is preferably controlled to be predetermined sizes by selecting a specific size and shape of a topographical feature, such as the shape and/or diameter or peripheral dimensions of the dome-shaped end cap 40 at the growth site 26. This advantageously allows the membrane 10 to be used to grow CNT strands 38 having pre-selected, pre-defined characteristics, including chirality, cross-sectional shape, and cross-sectional dimension(s).

FIG. 5 shows a later stage of growth after that depicted by phase (d) of FIG. 1, in which a strand 38 of CNT has continued to grow and is optionally inflated with hydrogen gas (H₂) provided at a positive pressure at the lower face 24 of the porous support 12 so as to diffuse through the permeable catalyst layer 20 into the strand 38 of CNT. In this variation, the hydrogen gas is preferably supplied simultaneously with the hydrocarbon molecules. Additionally, it may be particularly advantageous for the membrane 10 to include one or more apertures 29 of the type represented in FIG. 4D to allow the hydrogen gas to more easily permeate through the membrane 10 to inflate the CNT strand 38 without rupturing the membrane 10. As previously noted, the aperture 29 in FIG. 4D is preferably larger than the H₂ gas molecule but smaller than molecules of the hydrocarbon(s) being utilized to form the CNT strands 38 in order to force the hydrocarbon molecules to permeate through the catalyst layer 20 while the hydrogen gas can freely pass unobstructed through the aperture 29 to inflate the CNT strand 38.

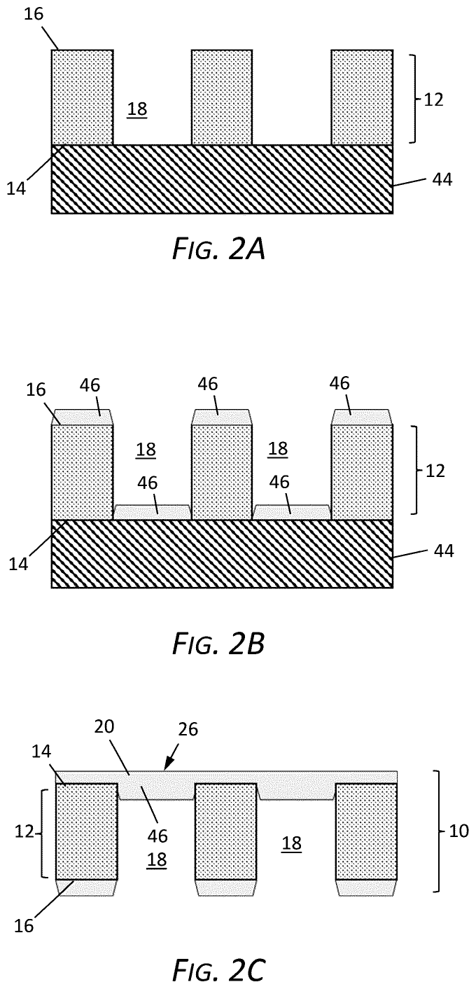

Turning generally to FIGS. 2A through 4D, some exemplary methods of forming a bi-facial catalytic membrane 10 according to nonlimiting aspects of the present invention are described.

FIGS. 2A-2C generally illustrate an embodiment of process steps to create a catalytic membrane 10 for forming a CNT “forest” having a common diameter. In FIG. 2A, the porous support 12 is formed on a sacrificial substrate 44. As previously noted, the porous support 12 may be formed of porous silicon. Porous silicon is an old technology, having been discovered more than 60 years ago at Bell Labs. Single-crystal silicon can be processed to form regular arrays of pits that lengthen into columnar pores having mouth diameters of about 2 to about 3.5 nm and depths of at least 150 micrometers. Alternatively, it is foreseeable that a porous support 12 can be fabricated by other means, for example, electrochemical etching a suitable thin substrate material.

In FIG. 2B, a directional coating of a catalyst has been deposited on the porous support 12 to form a permeable catalyst deposit 46. The catalyst may be a metal catalyst, though it is foreseeable that nonmetallic catalysts could be utilized or developed. In FIG. 2C the substrate 44 has been removed and an additional layer of the catalyst has been applied to form the catalyst layer 20, and with the support 12 form the catalytic membrane 10. Using porous silicon (poSi) as the porous support 12 brings several benefits. Porous silicon has been popular as a medical scaffolding material, a battery anode material, and as a hydrogen storage media for some time. However, the use of porous silicon as a component (porous support 12) of a porous catalytic membrane 10 is believed to be unique in that Knudsen flow governs hydrocarbon delivery to the backside of the catalyst layer 20, and can preclude larger molecules such as aromatic rings, keeping the feedstock pure.

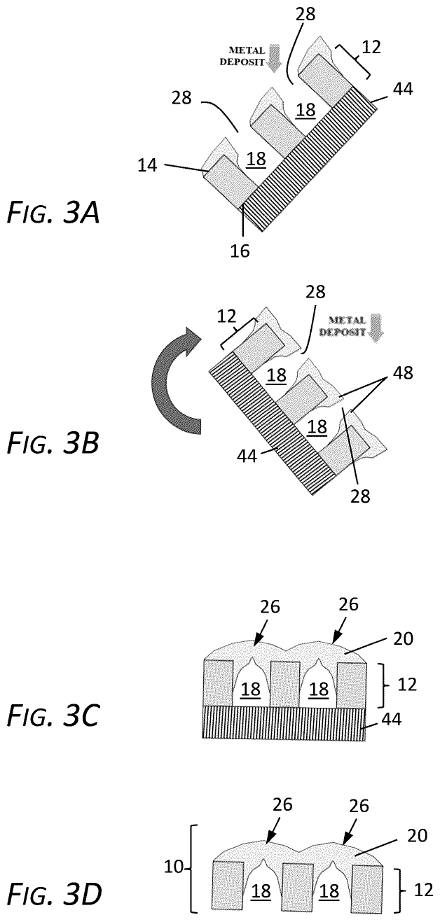

FIGS. 3A-D generally illustrate another embodiment of process steps to create a catalytic membrane 10. In FIG. 3A, the sacrificial substrate 44 supports the porous support 12, which is subject to a directional deposit of catalyst of a given type to form the catalyst layer 20. In FIG. 3B, the direction has been altered (rotated) to create crowns 48 on edges of the pores 18 to form apertures 28 in the catalyst layer 20 at the mouths of the pores 18. In FIG. 3C, continued deposition of the catalyst has resulted in the apertures 28 being closed and the resulting catalyst layer 20 having a dome shape at growth sites 26 over each pore 18. In FIG. 3D, after being freed from the substrate 44, the catalyst layer 20 on the porous support 12 yields the membrane 10, which can be used to nucleate and grow continuous strands 38 of CNTs directly from the porous support 12, supplied by hydrocarbon gases from around, and from behind, the membrane 10. The pores 18 are sized to be large enough to accommodate hydrocarbon molecules of the hydrocarbon gas utilized in the process. If not closed (e.g., FIG. 4D), there may be a benefit if each aperture 28 is smaller than a carbon atom, but not smaller than a hydrogen molecule, which may help to inflate, and keep rigid, the growing CNT strand. The dome-shaped growth sites 26 can be formed to have a desired radius of curvature by controlling the angle at which the porous support 12 is held relative to the substantially linear arrival of the catalyst deposited by the directional coating process. A steeper angle will form a more “peaked” dome shape having a smaller radius of curvature. In this manner, the shape and size of the end cap 40 can be controlled.

In order to effectuate the angled, directional metal deposition illustrated in FIGS. 3A and 3B, various approaches are possible. One nonlimiting example solution is to use an angled, rotatable chuck inside a sputterer or evaporative deposition chamber. Another non-limiting example solution is to use an adapted Denton metallizer with pinhole collimating filter and angled deposit surface. Yet another non-limiting example solution is to use a bell jar evaporative line-of-sight apparatus with a rigged fixture holder. Other solutions are also possible.

As represented in FIGS. 4A-4D, the catalyst layer 20 may be formed of two different catalysts: a first catalyst 30 that coats the porous support 12 and a second catalyst 32 disposed on the first catalyst 30. The first catalyst 30 can be selected to dissociate hydrocarbons and set loose hydrogen ions. Suitable materials for the first catalyst 30 may include, but are not limited to, one or more of palladium (Pd), protactinium (Pa), and ruthenium (Ru). The second catalyst 32 can be selected to spur carbon into graphene. Suitable materials for the second catalyst 32 may include, but are not limited to, transition metals, as a nonlimiting example, nickel (Ni). Distinct areas of each of the first and second catalysts 30 and 32 are preferably exposed to define the upper face 22 of the catalytic membrane 10. In FIG. 4B, the second catalyst 32 forms annular areas, such as ring shapes, surrounding apertures 28 that were formed within the first catalyst 30. The first catalyst 30 surrounds the outer perimeter of each annular area and is disposed between adjacent annular areas.

The process represented by FIGS. 4A-4D can be accomplished by briefly depositing the second catalyst 32 prior to one or more of the apertures 28 being filled and closed (FIG. 4B), after which the apertures 28 are closed by a subsequent deposition of the first catalyst 30 (FIG. 4C). The annulus of the second catalyst 32 can be re-exposed by directional removal of the second deposition of the first catalyst 30 from the surface-down (FIG. 4D), such as by chem-mechanical polishing (CMP). FIG. 4D shows the cross-section of the final configuration of an annular region 50 of the second catalyst 32 within the first catalyst 30. Carbon can arrive from the top side (upper face 22 of the membrane 10) if the substrate 44 is intact, or the substrate 44 can be removed for use in a permeable membrane configuration with backside (lower surface 24 of the membrane 10) feed, as shown for example in FIG. 1. It should be noted that the method represented in FIGS. 4A through 4D does not generate growth sites 26 having dome shapes because of the flattening effect of the directional removal process. Alternative processes, for example, selective electroless deposition, could be used to preferentially deposit atoms of the first catalyst 30. With suitable chemical solutions and possibly electrochemical potentials, such a preferential growth process for the first catalyst 30 is capable of producing mounds to generate dome-shaped end caps 40 of a CNT.

In view of the above, methods of manufacturing a bi-facial catalytic membrane 10 include directionally coating the first side 14 of the porous support 12 with a permeable catalyst to form the catalyst layer 20 covering one or more pores 18 of the porous support 12. The growth site 26 for an end cap 40 of a strand 38 of CNT that has a predefined chirality and diameter and is formed on the upper face 22 of the membrane 10. As discussed previously, the catalyst layer 20 is permeable in order to allow diffusion of carbon atoms, such as from the hydrocarbon feed 36, therethrough.

In the method variation illustrated in FIGS. 2A-2C, the porous support 12 is formed on the removable substrate 44 such that the removable substrate 44 is disposed on the first side 14 of the porous support 12. Thereafter, the second side 16 of the porous support 12 is coated with the permeable catalyst to form the catalyst deposit 46 in each of one or more of the pores 18 with a portion of the catalyst deposit 46 disposed against the removable substrate 44. The catalyst deposit 46 also preferably covers the exposed surfaces of the porous support 12 on the second side 16 thereof. After the catalyst deposit(s) 46 are formed, the removable substrate 44 is removed from the porous support 12 to expose the first side 14 thereof, as well as the to expose the catalyst deposits 46, which are substantially flush with the first side 14. After removing the substrate 44, the first side 14 is then directionally coated with the permeable catalyst such that the catalyst layer 20 is formed and engages the catalyst deposit(s) 46 in the pore(s) 18. In this method, the growth sites 26 are formed opposite the respective catalyst deposits 46.

In the method variation illustrated in FIGS. 3A-3D, the porous support 12 is formed on the removable substrate 44 with the removable substrate 44 disposed on the second side 16 of the porous support 12. The first side 14 of the porous support 12 is directionally coated after the porous support 12 is formed on the removable substrate 44. After the catalyst layer 20 is formed, the removable substrate 44 is removed from the porous support 12. As best seen in FIGS. 3A and 3B, the process of directionally coating the catalyst generally includes applying the permeable catalyst to the porous support 12 at one or more non-orthogonal directions relative to the first side 14 of the porous support 12. In this variation the crown 48 is formed around the periphery of the pore 18 by directionally applying the permeable catalyst in more than one non-orthogonal direction. There may be a plurality of such directions, equal in elevation from the primary axis of the pore 18, but spaced at various azimuthal angles so as to be substantially radially symmetric. The crown 48 defines the aperture 28 through its center. For example, either or both of the porous support 12 and an applicator for the permeable catalyst, such as a nozzle, may be rotated to change the direction of application of the permeable catalyst to a second non-orthogonal direction to the first side. The permeable catalyst may then be directionally applied in the second non-orthogonal direction to create the crown 48 around the pore 18. The catalyst is preferably deposited continuously while the direction of application is rotated so that, for example, the direction of application rotates a full 360° to ensure an even crown formation around the entire periphery of the pore 18. In this variation, a dome shape can be formed opposite the pore 18 by applying enough of the catalyst to close over the aperture 28 through the crown 48, as best seen in FIG. 3C. Thereafter, the removable substrate 44 is removed from the porous support 12 as shown at FIG. 3D to also expose the lower face 24 of the bifacial catalytic membrane 10.

In the method variation illustrated in FIGS. 4A-4D, the catalyst layer 20 with two different catalysts, the first catalyst 30 and the second catalyst 32, is created. In this variation, FIG. 4A, shows the crown(s) 48 formed in generally the same way as described with reference to FIGS. 3A and B with the first catalyst 30. As shown in FIG. 4B, before the aperture 28 is closed over, the coating process is changed to the second catalyst 32 and a thin coating of the second catalyst 32 is applied onto the coating of the first catalyst 30. The coating of the second catalyst 32 coats the crown(s) 48 without closing the aperture(s) 28 within the crown(s) 48, and forms an annular region 50 that surrounds the apertures 28 and forms the interior walls of the apertures 28. As shown in FIG. 4C, the coating process is then changed again back to the first catalyst 30 and a second coating of the first catalyst 30 is applied over the second catalyst 32 until the second coating of the first catalyst 30 closes over the apertures 28 and at least partially fills the apertures 28. The annular region 50 is aligned with the pore 18 and disposed within the first catalyst 30 such that the first catalyst 30 is disposed both in a central area of the annular region 50 and surrounds the annular region 50. Thereafter, as seen in FIG. 4D, the surface formed by the last-deposited first catalyst 30 is polished down to expose at least one of the annular regions 50 formed by the second catalyst 32. The upper face 22 may be polished so as to leave the aperture 28 closed and covered over by the first catalyst 30 inside the annular region 50, as shown on the left side if FIG. 4D, or the upper face 22 may be polished down until the aperture 28 is reopened as shown on the right side of FIG. 4D, creating an aperture 29 within the annular region 50 of the corresponding aperture 28. The aperture 29 is exposed in the upper face 22 of the membrane 10, has a cross-sectional area is less than that of the aperture 28 from which it was formed, and may have a circular, oval, or polygonal shape.

Semiconductor fabrication equipment capable of performing these process steps described above are well known and widely available. The directional deposition of metals, at sharp angles, is a notable process capability. There may be alternative options using conformal growth in electric fields to enhance corner growth, etc., however, it is generally desirable to enable ultra-dense forests of continuous zero-chirality CNTs in strands 38 of continuous lengths without limit.

It may be desired to form or bond the porous support 12 to the removable substrate 44. To accomplish this, the porous support 12 may be formed on an insulator, use black wax, a Langmuir film (also known as “Langmuir-Blodgett” (LB) films and “Langmuir monolayers”), have self-separation from porous support 12, and/or use spin-coat polymers.

To form a catalyst surface that will initiate CNT formation of a specific diameter, a catalyst layer 20 having a flat surface as shown in FIG. 2C may be sufficient. However, a catalyst surface with a topological feature, preferably a dome or similar shape that protrudes outwardly from the catalyst surface, is believed to be preferred.

For the catalytic membrane 10 to grow continuous strands 38 of CNTs, closure of the gap (i.e., the pore 18 through the porous support 12), is optional, but is preferred to only admit H₂.

The methods and apparatuses disclosed herein may form interlinked graphene without Stone-Wales defects.

A risk with methods and apparatuses as disclosed herein is the possibility of rupturing the catalytic membrane 10 during mounting of the ultra-thin membrane 10 and/or a due to a large pressure differential which could cause a rupture after mounting. Although a pressure differential is desired, as it can drive faster growth rate, diffusion and partial pressure gradients may be utilized to reduce the risk of rupture while growing CNT strands. Also, the size, in particular the two-dimensional area, of the catalytic membrane 10 can be maintained at a relatively small scale, such as using a film at a centimeter-sized wafer scale. Alternatively or in addition, an alumina honeycomb support may be used to the support the bi-facial catalytic membrane 10. Another approach is to use embedded films in impermeable media.

Many potential applications of the technology and invention(s) disclosed herein are possible, both on earth and in space, a few examples of which are discussed here.

A columnar CNT cable created by the methods described herein, having a cross-sectional area of 3.0 cm² is capable of having a resistivity of about 1.3e-8 Ωm, which is lower than that of copper, at a mass fraction of just 14.4%. The same CNT cable is capable of having about half the resistance of an aluminum cable at about half the mass, for a 4× improvement in specific mass.

Strength is expected to be no lower than 1100 MPa for an ideal CNT strand 38. A cable of indefinite length will exhibit this tensile strength, or better. When incorporated into a composite or woven braid, the tensile strength may differ. The same cable can be used for wired power as well as for towing, binding, and tensegrity.

Strands 38 of CNTs formed according to this disclosure could have a large number of practical uses on earth, as nonlimiting examples, to fabricate structures such as electrical cables and structural members of buildings. However, it is also believed that the CNT strands 38 would have substantial practical uses in outer space applications as well. For example, as technology evolves, Mars' moons may be relocated to an aerostationary orbit to provide a proper space elevator with anchor. A woven ribbon formed by knitting many such CNT cables formed from the CNT strands 38 disclosed herein can then be used to build various structures capable of use in outer space, as nonlimiting examples, tether systems and space elevators. Strong CNT cables may also be useful in producing large-scale zero-G rotating habitats, for example to provide compressive strength to maintain structural integrity. CNT cables made from the technology described herein can provide power management and distribution between generation sources, energy storage, and loads for lunar operations.

Another application is in the ATLAS detector of the Large Hadron Collider, which requires low-Z cables for the first two meters between the silicon detector and the analytical equipment. Many other applications abound for aircraft and spacecraft, in situ resource utilization, electric vehicles, high-tension power lines, and suspension bridges. Once established, the methods and technologies disclosed herein are believed to be able to produce large quantities of ideal CNT cables at relatively low cost.

In addition to their structural benefits as tethers and space elevators, CNT strands with zero chiral angle are also excellent conductors. Lightweight electrical cables made from the zero-chiral CNT strands 38 can be used for such applications as distributed resource utilization operations on planetary surface for power management and distribution.

The methods and apparatuses disclosed herein are preferably capable of producing zero-angle CNTs having excellent conductive properties with low defect rates, and sufficient length to form continuous, indefinite-length aligned forests of CNTs.

Foreseeable implementations of the methods and technology disclosed herein also include application in outer space. For example, Phobos, a moon of the planet Mars, is carbon-rich and could be used as feedstock for producing zero-chirality carbon nano-tubes of unlimited extent in accordance with certain nonlimiting aspects of the present invention. The composition of low-orbiting Phobos is believed to be carbon-rich rock, owing to its low albedo. It is believed that Phobos has limited hydrogen, and therefore a limited amount of hydrogen for processing the growth of the CNTs would be brought from elsewhere. With heat and a hydrogen environment, the carbon-rich minerals on Phobos will produce methane, which is used to grow the CNT cables. The hydrogen will be stripped away during the growth process and can be recycled.

As previously noted above, though the foregoing detailed description describes certain aspects of one or more particular embodiments of the invention, alternatives could be adopted by one skilled in the art. For example, the membrane 10, CNT strands 38, and their components could differ in appearance and construction from the embodiments described herein and shown in the drawings, functions of certain components could be performed by components of different construction but capable of a similar (though not necessarily equivalent) function, and various materials could be used in the fabrication of the membrane 10 and CNT strands 38 and/or their components. As such, and again as was previously noted, it should be understood that the invention is not necessarily limited to any particular embodiment described herein or illustrated in the drawings.

1: An apparatus for manufacturing a continuous strand of zero-chiral carbon nanotube, the apparatus having a bi-facial catalytic membrane comprising:
a porous support having opposite first and second sides, wherein the porous support comprises at least one pore extending through the porous support; and
a catalyst layer disposed on the first side of the porous support and covering the pore;
wherein a surface of the catalyst layer opposite the porous support defines a first face of the bi-facial catalytic membrane and the second side of the porous support defines a second face of the bi-facial catalytic membrane, and
wherein the catalyst layer is permeable to allow diffusion of carbon atoms therethrough, and
wherein the first face is configured to form an end cap of a carbon nanotube, the first face defines the diameter of the carbon nanotube, and the carbon nanotube has a predefined chirality and diameter.

2: The apparatus of claim 1, wherein the porous support is formed of porous silicon.

3: The apparatus of claim 1, wherein the catalyst layer further comprises a topological feature on the first face aligned opposite the pore, wherein the topological feature is configured to form the end cap of the carbon nanotube.

4: The apparatus of claim 3, wherein the topological feature has a dome shape projecting outwardly from the first face.

5: The apparatus of claim 1, comprising an aperture through the catalyst layer at the topological feature, wherein the aperture is smaller than a carbon atom and larger than a hydrogen molecule.

6: The apparatus of claim 1, wherein the pore has a lateral dimension of about 2-5 nm in a direction transverse to an axial direction through the porous support.

7: The apparatus of claim 1, wherein the porous support comprises a plurality of pores, and the catalyst layer covers the plurality of pores.

8: The apparatus of claim 7, wherein the catalyst layer further comprises a plurality of topological feature on the first face, one of the topological features aligned opposite each pore, wherein each topological feature is configured to form an end cap of a carbon nanotube.

9: The apparatus of claim 1, wherein the catalyst layer comprises a first catalyst that coats the porous support and a second catalyst disposed on the first catalyst, wherein the first catalyst dissociates hydrocarbons and sets loose hydrogen ions, wherein the second catalyst spurs carbon into graphene, and wherein distinct areas of each of the first catalyst and the second catalyst are exposed on the first face.

10: The apparatus of claim 9, wherein the first catalyst comprises one or more of Palladium (Pd), Protactinium (Pa), and Ruthenium (Ru).

11: The apparatus of claim 9, wherein the second catalyst comprises a transition metal.

12: The apparatus of claim 11, wherein the transition metal comprises nickel (Ni).

13: A method of manufacturing a continuous strand of zero-chiral carbon nanotube, the method comprising:
forming a dome formed of interlinked cyclic graphene hexagons at a growth site on a permeable catalyst layer disposed on a porous support, wherein the growth site is located over a pore in the porous support; and
continuously growing a strand of zero-chiral nanotube from the dome by providing a hydrocarbon feed at a positive pressure through the porous support and the permeable catalyst layer toward the dome.

14: The method of claim 13, further comprising:
inflating the strand of carbon nanotube with hydrogen gas provided at a positive pressure along the porous support so as to diffuse through the permeable catalyst layer into the strand of carbon nanotube.

15: The method of claim 13, further comprising:
controlling diameter and shape of the dome by selecting a size and shape of a topographical feature at the growth site.

16: A method of manufacturing a bi-facial catalytic membrane for manufacturing a continuous strand of zero-chiral carbon nanotube, the method comprising:
directionally coating a first side of a porous support with a permeable catalyst to form a catalyst layer covering a pore of the porous support, wherein the catalyst layer is permeable to allow diffusion of carbon atoms therethrough, wherein a surface of the catalyst layer opposite the porous support defines a first face of the bi-facial catalytic membrane, and wherein a second side of the porous support opposite the first side defines a second face of the bi-facial catalytic membrane; and
forming a growth site for an end cap of a carbon nanotube, the first face defines the diameter of the carbon nanotube, and the carbon nanotube has a predefined chirality and diameter.

17: The method of claim 16, further comprising:
forming the porous support on a removable substrate, wherein the removable substrate is disposed on the first side;
coating the second side of the porous support with the permeable catalyst to form a catalyst deposit in a pore of the porous support disposed against the removable substrate;
removing the removable substrate from the porous support to expose the first side; and
wherein the step of directionally coating the first side of the porous substrate is performed after the step of removing the removable substrate,
and wherein the step of directionally coating the first side comprises applying the permeable catalyst such that the catalyst layer engages the catalyst deposit in the pore, wherein the growth site is formed opposite the catalyst deposit.

18: The method of claim 16, comprising:
forming the porous support on a removable substrate, wherein the removable substrate is disposed on the second side;
directionally coating the first side after the porous support is formed on the removable substrate; and
removing the removable substrate from the porous support after the catalyst layer is formed.

19: The method of claim 17, wherein the porous support comprises porous silicon.

20: The method of claim 18, wherein the step of directionally coating the first side comprises directionally applying the permeable catalyst at a direction other than orthogonal to the first side of the porous support.

21: The method of claim 20, wherein the step of directionally coating the first side comprises:
directionally applying the permeable catalyst in a first non-orthogonal direction to the first side;
rotating at least one of the porous supports and an applicator for the permeable catalyst to change a direction of application of the permeable catalyst to a second non-orthogonal direction to the first side; and
directionally applying the permeable catalyst in the second non-orthogonal direction to create a crown around the pore.

22: The method of claim 21, wherein the step of directionally applying the permeable catalyst in the second non-orthogonal direction comprises:
forming a dome shape that closes an aperture through the crown.

23: The method of claim 21, wherein the steps of directionally applying the permeable catalyst in a first non-orthogonal direction to the first side and directionally applying the permeable catalyst in the second non-orthogonal direction to create a crown around the pore are performed with a first catalyst; and
wherein the step of directionally coating the first side comprises:
coating the first catalyst with a second catalyst on the crown; and
applying a second coating of the first catalyst over the second catalyst, wherein the second coating of the first catalyst closes an aperture through the crown.

24: The method of claim 23, further comprising:
polishing the first face to expose an annular region of the second catalyst disposed within the first catalyst aligned with the pore, wherein first catalyst is disposed in a central area of the annular region and surrounding the central area in the first face.

25: The method of claim 24, wherein the step of polishing includes reopening the aperture.

26: A structure comprising:
a first strand of the zero-chiral carbon nanotube of claim 1; and
a second strand of the zero-chiral carbon nanotube of claim 1,
wherein the first strand is knitted together with the second strand to form a portion of the structure.

27: The structure of claim 26, wherein the structure comprises a space tether.

28: The structure of claim 26, wherein the structure comprises a space elevator.

29: The structure of claim 26, wherein the structure comprises an electrical cable.

30: The structure of claim 26, wherein the structure comprises a structural member of a building.
